(19) United States
(12) Patent Application Publication
(10) Pub. No.: US 2004/0195542 A1
(43) Pub. Date: Oct. 7, 2004

(54) Enhanced electromechanical properties in atomically-ordered ferroelectric alloys

(76) Inventors: Laurent Bellaiche, Fayetteville, AR (US); Aaron M. George, Summerfield, NC (US); Jorge Iniguez, Gaithersburg, MD (US)

Correspondence Address: Wright, Lindsey & Jennings LLP, Suite 2300, 200 West Capitol Avenue, Little Rock, AR, 72201, US

(21) Appl. No.: 10/632,740

(22) Filed: Aug. 1, 2003

Related U.S. Application Data
(60) Provisional application No. 60/401,995, filed on Aug. 8, 2002.

(51) Int. Cl. C04B 35/00

(52) U.S. Cl. 252/62.9 R; 501/134

(57) ABSTRACT

Complex insulating perovskite alloys are of considerable technological interest because of their large dielectric and piezoelectric responses. A certain class of atomic rearrangement should lead simultaneously to large electromechanical responses and to unusual structural phases in a given class of perovskite alloys. In particular, new ferroelectric alloy materials having enhanced electromechanical properties may be obtained by rearranging the ordering of atoms in stacked planes where the alloy is atomically ordered along a direction that is not the direction of polarization of the disordered alloy; the stacking is short; and the atoms belong to different columns of the periodic table. The enhanced electromechanical properties may be obtained at any specific temperature less than the Curie temperature of the disordered alloy.

### CROSS-REFERENCE TO RELATED APPLICATIONS

This application claims the benefit of U.S. Provisional Patent Application No. 60/401,995 filed Aug. 8, 2002.

### STATEMENT REGARDING FEDERALLY SPONSORED RESEARCH OR DEVELOPMENT

This invention was made using support from agencies of the United States Government: Office of Naval Research Grant Nos. N00014-00-1-0542 and N00014-01-1-0600 and National Science Foundation Grant No. DMR-9983678. The government has certain rights in the invention.

### BACKGROUND OF THE INVENTION

Complex insulating perovskite alloys are of considerable technological interest because of their large dielectric and piezoelectric responses. Examples of such alloys include (Ba₁₋ₓSrₓ)TiO₃, which has emerged as a leading candidate dielectric material for the memory-cell capacitors in dynamic random access memory [Ref. 1], and Pb(Zr₁₋ₓTiₓ)O₃ (PZT), which is widely used in transducers and actuators [Ref. 2]. The rich variety of structural phases that these alloys can exhibit, and the challenge of relating their anomalous properties to the microscopic structure, make them attractive from a fundamental point of view. Theoretical investigations of modifications to the atomic ordering of these alloys suggest the existence of further unexpected structural properties [Ref. 3].

### SUMMARY OF THE INVENTION

Here, we report ab initio calculations that show that a certain class of atomic rearrangement should lead simultaneously to large electromechanical responses and to unusual structural phases in a given class of perovskite alloys. Our simulations also reveal the microscopic mechanism responsible for these anomalies.

According to the present invention, new ferroelectric alloy materials having enhanced electromechanical properties may be obtained by rearranging the ordering of atoms in stacked planes meeting the following requirements:

(1) the alloy is atomically ordered along a direction that is not the direction of polarization of the disordered alloy;

(2) the stacking is short; e.g., a four-plane period has been calculated to produce large enhancements; and

(3) the atoms belong to different columns of the periodic table.

### BRIEF DESCRIPTION OF THE DRAWING FIGURES

FIG. 1 is a schematic representation of the Pb(Sc³⁺_{0.5+ν}Nb⁵⁺_{005-ν})O₃/Pb(Sc³⁺_{0.5}Nb⁵⁺_{0.5})O₃/Pb(Sc³⁺_{0.5-ν}Nb⁵⁺_{0.5+ν})O₃/Pb(Sc³⁺_{0.5}Nb⁵⁺_{0.5})O₃ structures considered here. The internal electric fields acting on the four B planes are displayed by means of arrows.

FIGS. 2a-c show the properties of the studied structures as a function of the ν parameter at 20 K. a, Average Cartesian coordinates uₓ, u_{y} and u_{z} of the local mode; b, the d₃₄ piezoelectric coefficient; c, the χ₃₃ dielectric susceptibility. The filled symbols in a represents the Cartesian coordinates uₓ(LDA), u_{y}(LDA) and u_{z}(LDA) of the local modes predicted by direct first-principles calculations using the local density approximation [Refs. 9-12]. a.u., arbitrary units.

FIGS. 3a-c show the properties of the structure associated with ν=0.375 as a function of temperature. Panels a, b and c display the same property as the corresponding panels of FIG. 2. Dashed line in a shows one the three Cartesian coordinates (uₓ) of the local mode in disordered (dis) PSN (the two other Cartesian coordinates are nearly identical to the one displayed, and are omitted for clarity).

FIG. 4 shows a sawtooth modulation function.

FIG. 5 is a planar composition modulation scheme.

FIGS. 6a-l show a composition modulation table: Niobium concentration, soft local modes and mean field calculation as a result of varying parameters A and λ, as defined hereinafter. In FIGS. 6a, 6e, and 6i, modulation is by a sine wave with A=0.25 and λ=12a. In FIGS. 6b, 6f, and 6j, modulation is by a sawtooth wave with A=0.25 and λ=12a. In FIGS. 6c, 6g, and 6k, modulation is by a sine wave with A=0.5 and λ=12a. In FIGS. 6d, 6h, and 6l, modulation is by a sawtooth wave with A=0.25 and λ=4a.

### DETAILED DESCRIPTION OF THE PREFERRED EMBODIMENTS

The class of Pb(Mg_{1/3}N_{2/3})O₃—PbTiO₃ (PMN-PT) and Pb(Zn_{1/3}Nb_{2/3})O₃—PbTiO₃ (PZN-PT) perovskite ferroelectric alloys have been reported [Ref. 4] to show remarkably large piezoelectric constants around 2,000 pC/N. These materials thus promise improvements in the resolution and range of ultrasonic and sonar listening devices [Ref. 5]. Perovskite A(B′B″ . . . )O₃ alloys are also of great interest, as demonstrated by the discovery of an unexpected monoclinic phase [Ref. 6] in Pb(Zr₁₋ₓTiₓ)O₃. These two findings have led to the search for materials with even larger electromechanical response and/or currently unobserved phases. In particular, if a mechanism can be found that occurs in a large number of ferroelectric alloys, markedly enhances the piezoelectricity and the dielectric responses, and leads to unexpected structural features, that mechanism is likely to have large technological and fundamental implications. Here we report that such a mechanism exists and simply consists in rearranging in a certain way the atoms in a heterovalent alloy (that is, an alloy made of atoms belonging to different columns of the periodic table). More precisely, we predict that materials made of the following sequences Pb(Sc³⁺_{0.5+ν}Nb⁵⁺_{0.5-ν})O₃/Pb(Sc³⁺_{0.5}Nb⁵⁺_{0.5})O₃/Pb(Sc³⁺_{0.5-ν}Nb⁵⁺_{0.5+ν})O₃/Pb(Sc³⁺_{0.5}Nb⁵⁺_{0.5})O₃ along the [001] direction should show very large electromechanical responses, and unusual monoclinic and orthorhombic phases for some values of the ν parameter. The analysis of our results points to the different valence between the B atoms (Sc and Nb) as the main reason for the existence of these anomalous properties.

Here, we use the numerical scheme proposed in Refs. 7 and 8, which consists of constructing an alloy effective hamiltonian for the alloy from first-principles calculations, to predict the properties of Pb(Sc₁₋ₓNbₓ)O₃ (PSN) structures. This effective Hamiltonian [Refs. 7,8] contains a local-mode self-energy (expanded in even-order terms up to fourth order of the phonon local soft modes), a long-range dipole-dipole interaction, a short-range interaction between soft modes (quadratic order of the soft modes), an elastic energy (expanded to second order of the strain variables), and an interaction between the local modes and local strain (second order of the soft modes and linear order in strain). It also contains an energy term describing the effects of the atomic configuration on the phonon local soft modes (which are directly related to the electrical polarization) that can be written as equation (1):

$$Δ E = - {\sum }_{i} {Z}^{*} {u}_{i} \cdot [ {\sum }_{j} - {σ}_{j} {S}_{ji} {\hat{e}}_{ji} ] \qquad ( 1 )$$

where i runs over all the cells while j runs over the three nearest neighbors shells of cell i. Here uᵢ is the local soft mode in cell i, Z* is the Born effective charge associated with the local soft modes, and êⱼᵢ is the unit vector joining the B site j to the B site i. The variables {σⱼ} characterize the atomic configuration: σⱼ=+1 (−1) indicates there is a Nb (Sc) ion in cell j. Sⱼᵢ is an alloy-related parameter that only depends on the distance between the B sites i and j, and is derived by performing first-principles calculations [Refs. 9-12] on small cells. Equation (1) indicates that ΔE can be viewed as the interaction energy between the dipole moment Z* uᵢ associated with the site i and an internal electric field Σⱼ−σⱼSⱼᵢêⱼᵢ induced by the B ions of sites j on the site i. Moreover, we numerically find that the Sⱼᵢ parameters all have negative signs. As a result, the radial electric field −σⱼSⱼᵢêⱼᵢ acting on site i and induced by a Sc³⁺ (Nb⁵⁺) ion sitting on site j is directed from the site i to the site j (respectively, from site j to site i). This is consistent with an electrostatic picture of PSN since Sc (Nb) ions are negatively (positively) charged with respect to the average B-ion valence of 4+. The effective hamiltonian approach yields good agreement with direct first-principles results in PZT and PSN alloys [Refs. 7,8]. Previous works (see Refs. 7-8) have found that a linear resealing of the simulation temperature often leads to good agreement with experiment. Adopting this approach again here, our temperatures are rescaled down by a factor of 2.5 so that the theoretical Curie temperature in disordered PSN is forced to match the experimental value [Ref. 13]. The need for such resealing may be due to higher perturbative terms or the rotation of the oxygen octahedra, neglected in our effective model of PSN.

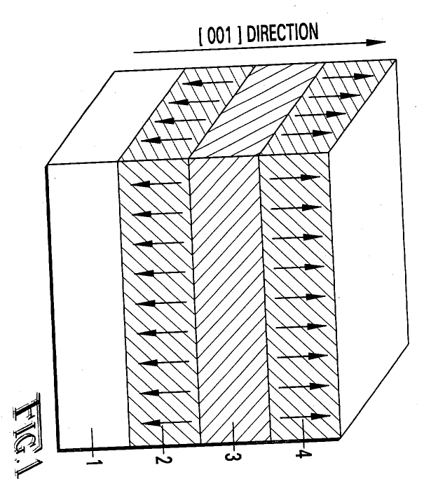

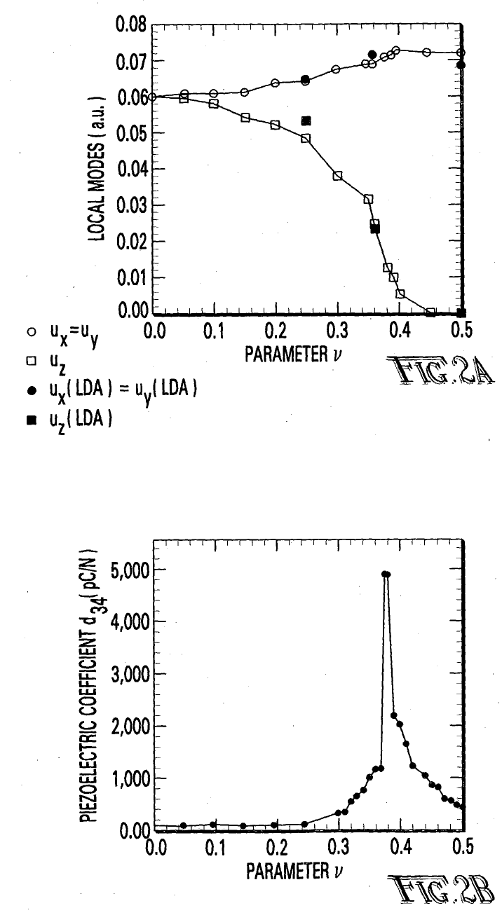

Here, we use the total energy of our alloy effective hamiltonian in Monte Carlo simulations to calculate finite-temperature properties of some selected Pb(Sc₁₋ₓNbₓ)O₃ structures. We consider structures with the following sequence of four B-planes along the [001] direction (FIG. 1): a niobium-poor plane 1 for which x=0:5−ν, a second plane 2 made of 50% scandium and 50% niobium (x=0.5), a niobium-rich plane 3 with x=0:5+ν, and a fourth plane 4 similar to the second one. The B atoms are randomly distributed inside each of these four planes. The studied structures only differ from the value of the parameter ν, which is allowed to vary from zero (in the case of the disordered PSN alloy) to 0.5 (in the case in which the first plane is entirely made of Sc atoms while the third plane is fully occupied by Nb atoms). We use 12×12×12 supercells, implying that the sequence of the four different B(001) planes is repeated three times, to get well-converged results [Refs. 7,8].

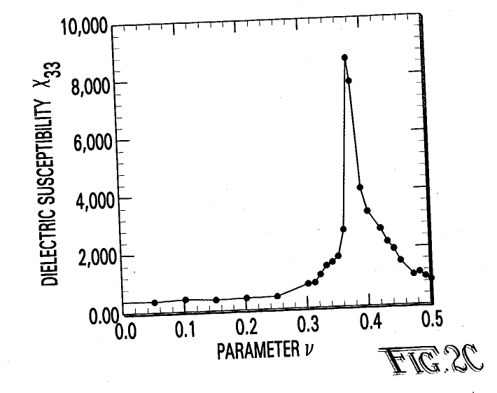

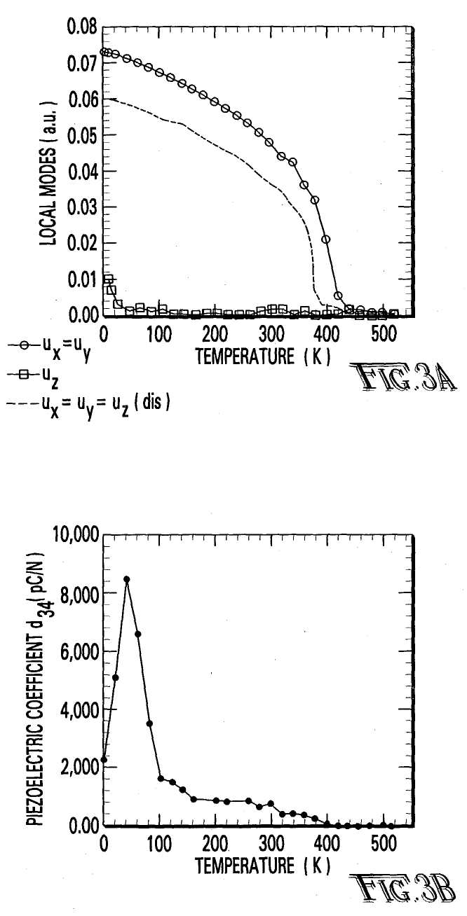

FIG. 2a shows the Cartesian coordinates (uₓ, u_{y} and u_{z})—along the [100], [010] and [001] directions, respectively—of the supercell average of the local mode vectors as a function of this parameter ν at 20 K. The structure for which ν is null exhibits uₓ=u_{y}=uₓ≠0. This characterizes a ferroelectric rhombohedral structure in which the polarization is directed along the pseudo-cubic [111] direction, consistent with experiments on disordered PSN samples [Ref. 13]. Interestingly, increasing ν results in a strong decrease of u_{z} while uₓ and u_{y} slowly increase and remain equal to each other. This behavior corresponds to a ferroelectric phase of monoclinic symmetry for which the polarization lies between the [111] and [110] directions (the one denoted MB in Ref. 14). When ν is larger than 0.44, u_{z} becomes null while uₓ and u_{y} reach their maximum value, indicating that the resulting phase is now of orthorhombic symmetry with a polarization lying along the [110] direction. Increasing the parameter ν thus leads to three different ground states and to a continuous rotation of the electrical polarization. To our knowledge, the predicted monoclinic M_{B} ground state has never been observed in any perovskite material without the aid of external stress or electric field. Similarly, we are not aware of any studies pointing to an orthorhombic ground state in PSN. The existence of these monoclinic and orthorhombic phases is due to the energy term described in equation (1). FIG. 2a also shows the predictions of local density approximation [Refs. 9-11] calculations performed on 20-atom supercells mimicking the structures corresponding to ν=0.25, ν=0.36 and ν=0.50. In these supercells, each B(001) plane is represented by a virtual atom corresponding to the composition in this plane [Refs. 12, 15]. The direct first-principles calculations agree with the predictions of our effective hamiltonian approach, thus further supporting the existence of these unusual monoclinic and orthorhombic phases.

FIG. 2b summarizes the effects of the parameter ν on piezoelectricity and FIG. 2c the effects on dielectric response at 20 K. We found that the electromechanical coefficients that are the most affected by the presently studied atomic ordering are the shear d₃₄ piezoelectric coefficient and the χ₃₃ dielectric susceptibility, when expressing both piezoelectric and dielectric tensors in the orthonormal basis formed by a₁=[100], a₂=[010] and a₃=[001]. More precisely, FIG. 2b shows that d₃₄ peaks and remains at large values for a broad range of ν centered around the monoclinic-to-orthorhombic phase transition. FIG. 2c demonstrates that the studied atomic ordering simultaneously results in a large dielectric response, as χ₃₃ achieves values above 1,000 at 20 K when ν is greater than 0.3.

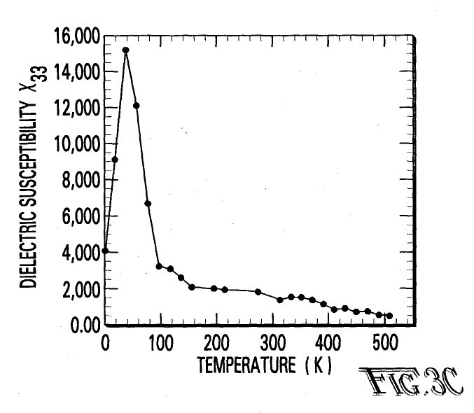

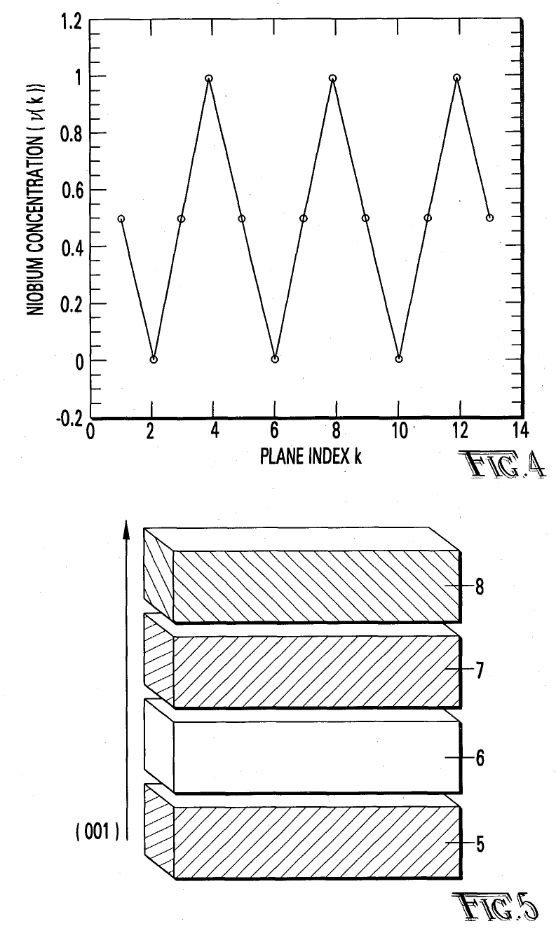

We now investigate the finite-temperature properties of a structure showing one of the largest electromechanical responses at 20 K. More precisely, we focus on the structure for which ν=0.375. FIG. 3a displays the Cartesian coordinates of the supercell average of the local mode vectors as a function of temperature for this structure, and compares them with those of the disordered PSN material. Each coordinate of the local mode in each structure is close to zero at high temperature, characterizing a paraelectric phase. At a temperature close to 373 K, the disordered material undergoes a transition from a paraelectric cubic phase to a ferroelectric rhombohedral structure (for which uₓ=u_{y}=u_{z}), consistent with experiments [Ref. 13]. The disordered PSN material then remains in the rhombohedral phase for lower temperature. On the other hand, the modulated structure with ν=0.375 adopts three different phases: a paralectric tetragonal phase induced by atomic ordering (for which uₓ=u_{y}=u_{z}=0) at high temperature, an orthorhombic ferroelectric phase (uₓ=u_{y}≠0 and u_{z}=0) for temperature between 400 K and 40 K, and the monoclinic ferroelectric M_{B} phase (uₓ=u_{y}>u_{z}, with u_{z}≠0) for temperature lower than 40 K. As shown in FIGS. 3b and c, the existence of the orthorhombic-to-monoclinic phase transition results in huge electromechanical responses peaking around this transition and occurring over a broad range of temperature. As a matter of fact, d₃₄ and χ₃₃ are greater than 1,500 pC/N and 3,000, respectively, for any temperature lower than 100 K.

We also numerically found (results not shown here) that continuously increasing ν from 0 to 0.44 leads to a continuous decrease of the orthorhombic-to-monoclinic transition temperature from 373 K to 0 K. As a result, the temperature at which d₃₄ and χ₃₃ both peak depends on the value of the ν parameter. This dependency could lead to the development of devices with electromechanical performances optimized for any temperature between 373 K and 0 K.

The intriguing results of FIGS. 2 and 3 can be understood by means of equation (1). The internal electric field Σⱼ−σⱼSⱼᵢêⱼᵢ acting on each B(001) plane is represented in FIG. 1. The atoms in plane 2 feel an internal electric field oriented along the [001] direction while the atoms in plane 4 are under an internal electric field that lies along the [001] direction. It is straightforward to demonstrate that the magnitude of these fields is linearly dependent on the parameter ν. (These features can be understood qualitatively by simple short-range electrostatic considerations: the difference of valence between Sc and Nb atoms leads to charged B(001) planes with ionic charges linearly dependent on ν. When electrostatic interactions up to the third-neighbor shells are included, these charged planes generate internal electric fields whose directions are those of FIG. 1 and whose magnitudes are linearly dependent on ν). Increasing ν thus results in stronger internal fields with opposite directions. These strong opposite fields tend to suppress the polarization's component along the direction of compositional modulation. As a result, u_{z} becomes smaller than uₓ and u_{y}. The studied structures with intermediate values of ν thus first undergo a paraelectric-to-orthorhombic ferroelectric transition at high temperature before adopting the monoclinic M_{B} phase for ground state. The modulated structures with the largest values of ν have the strongest internal electric fields, which annihilate u_{z} at any temperature. Consequently, such structures never reach the monoclinic phase and thus adopt the orthorhombic phase for ground state. The large values of d₃₄ and χ₃₃ shown in FIGS. 2 and 3 simply reflect the considerable change of u_{z} when some parameters are slightly modified (ν at a fixed temperature, or T for a fixed value of ν), especially for structures at the borderline between the monoclinic and orthorhombic phases. In other words, the large electromechanical responses are consistent with the ease of rotating the polarization [Refs., 7, 16]. We have shown here results for the thinnest possible structures. For larger structures, with thicker layers, the “unusual” electromechanical responses will be smaller due to smaller internal electric fields.

### EXAMPLES

Composition Modulation

It has been found that long range order in PSN can significantly change the Curie temperature, the temperature at which the crystal makes a transition from the paraelectric to ferroelectric phase [Ref. 8]. Long range order has been shown to suppress the relaxor behavior which PSN displays in a disordered structure. These findings point to the role of other types of compositional ordering at the B site in PSN. A functional ordering that can produce interesting results is composition modulation, where the composition is allowed to vary inside the material along a predetermined direction. Since the VCA (virtual crystal approximation) alone is unable to simulate ordering, composition modulation is accomplished by manipulating σᵢ in the expression of effective energy. Many parameters related to composition modulation can be changed to accomplish significant changes in electromechanical responses and structural phases in the crystal. The first parameter to consider is ν, the role of which can be seen by writing the general chemical formula which characterizes various compositions of PSN. In Pb(Sc_{1-ν(k)}Nb_{ν(k)})O₃, a few notes should be made on ν. First ν is dependent on k, k denotes the plane number in the [001] direction; second ν is assigned a value between 0 and 1 to simulate the composition of the B metal by plane and must function in such a way to maintain charge neutrality in the crystal. To expand ν:

ν(k)=ν₀+Af(k) (2)

where ν₀ denotes the average composition. A is the amplitude of modulation, also known as the deviation from the mean composition ν₀. A ranges from 0 to 0.5. In PSN, to maintain charge neutrality over the whole structure, f(k), the modulation function dependent on plane index k, was constrained so that:

Σ^{λ}ₖ[f(k)]=0 (3)

λ is the wavelength of modulation, which was kept smaller than one dimension of the supercell. For null value of A, the composition by plane, ν(k), is that of the average. For the maximum value of A, a plane can be completely composed of one element, either Scandium or Niobium, which plane has this composition is determined by the modulation function. Here, one modulation function often used is:

f(k)=sin(2πk/λ) (4)

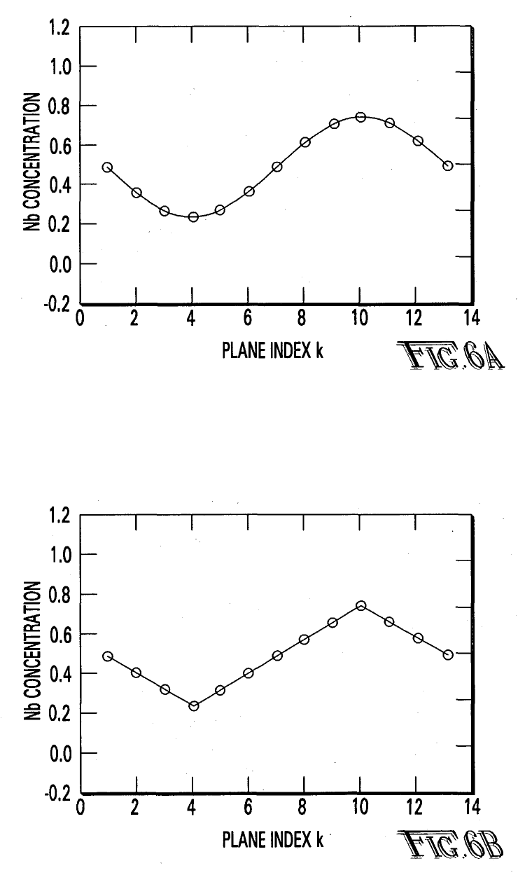

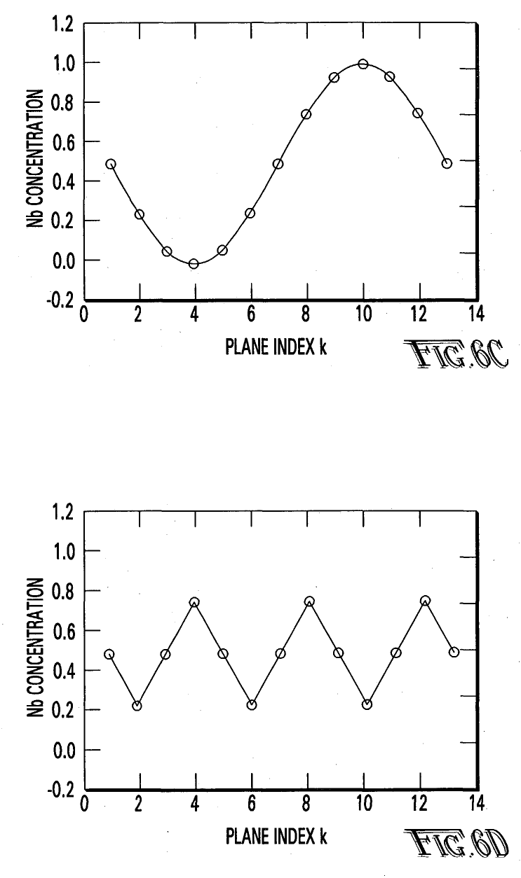

although any selection of various repeating functions will suffice to satisfy the constraints. For example, a selection of a linearly increasing, then decreasing, “sawtooth” function is used (see FIG. 4). The sine function yields this modulation when the parameter λ=4a is supplied. However, another “sawtooth” function used later has the parameter λ=12a. This is not defined by the sine function but does satisfy the requirements of the modulating function, i.e. Eq. (3).

Once an analytical expression for the energy is found, the Metropolis Monte Carlo method is employed. In this case there are two degrees of freedom, in the local modes uᵢ and strain ηᵢ. When the simulation is performed, a 12×12×12 supercell is used, giving 1728 sites in the supercell, yielding well converged results. Once a composition and temperature for a supercell is chosen, it remains unchanging for the simulation. 40,000 steps are performed to equilibrate the system, then the same number are performed again, with monitoring of the local modes uᵢ and strain ηᵢ to get statistical information including averages for each step.

Many parameters can be manipulated in the modulating function. Some will be discussed here and the results of which will be presented following. In all but one case, in order to accomplish composition modulation, the function given in f(k)=sin(2πk/λ) was used. The other function used was a linear sawtooth function. Two different sets of modulations were defined by λ=12a and λ=4a, where a is the lattice constant determined from first principle calculations. In both cases, simulations were performed with amplitudes ranging from A=0 to A=0.5 (at a constant temperature, usually 50 K) and temperatures ranging from 1300 K down to 5 K (temperature before resealing.) It should be noted at this point that the temperatures used must be rescaled to correspond to the experimental values, the reference temperature being the Curie temperature corresponding to the experimental, T_{C;exp}, value, then the theoretical Curie temperature is denoted by, T_{C;calc}. However great the difference may be between the experiment and theoretical value, three points can be made to verify the validity of this resealing of temperature. First, the resealing is linear, that is each T_{calc} is multiplied by the factor T_{C;exp}/T_{C;calc}. Second, an explanation for this temperature dependent energy difference between calculated and experimental data has been proposed, that is neglected higher order perturbative terms in the total energy or a physical twisting of the oxygen lattice about the B lattice, unaccounted for in the approximation of the effective energy. Third, this method of resealing the temperature has yielded very good agreement with experimental values in the past. For example, in disordered PSN the room temperature angle between primitive lattice vectors agrees very well with experiment, after the temperature is rescaled. Moving on, if no composition modulation is accomplished, the average composition for the crystal is normally chosen, then the sites are seeded with the alloying elements in a completely disordered manner. This is accomplished by choosing σⱼ randomly. The composition modulation in the [001] direction, ν, then affects the populations of σⱼ corresponding to the (001) planes. Each plane in the [001] direction is assigned a total composition, however, the planar composition of the actual elements remains disordered. For example, in PSN, if ν(k) is constant, 0.5, then the structure has an average composition of Sc and Nb of 0.5 in each plane. The results of this modulation can (and will) then be compared to a completely disordered structure of Nb_{0.5} and Sc_{0.5} over the supercell, with little difference to be noticed.

FIG. 4 illustrates a sample of one of the modulations used in this study. A saw function determines the Niobium (and Scandium) composition of planes indexed by k in the supercell. The saw modulation harbors two interesting parameters, λ and the amplitude of modulation, A. When λ=4a was used, this being determined in part by the size of the supercell, the sine function yields a saw modulation. As seen previously, A can take on values between 0 and 0.5, limited by the resolution again determined by the size of the supercell, as the smallest increment of A by plane is 1/144 yielding 72 possible values of A.

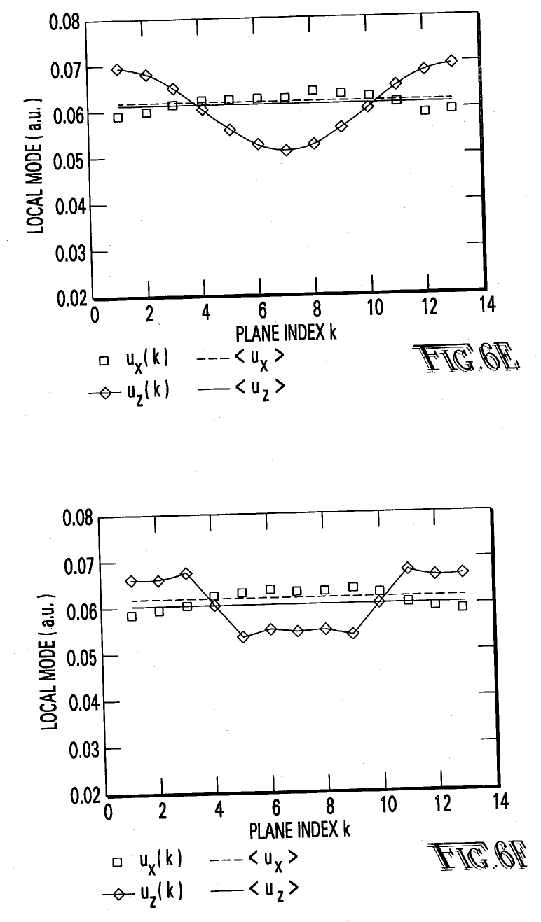

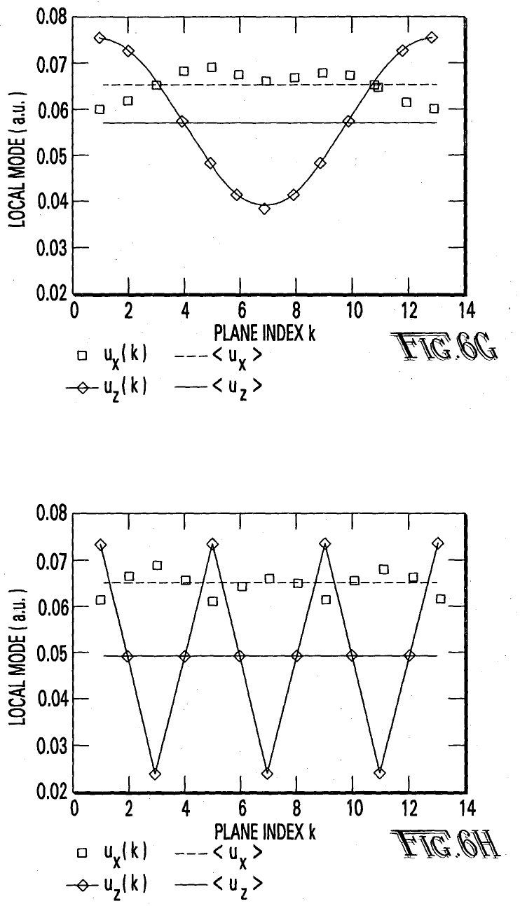

Illustrated in FIG. 5 is a one wavelength planar schematic of the modulation characterized by λ=4a, and A=0.5. The direction of the modulation is [001], that is each plane k has an average composition differing in this direction. Starting at the bottom of the figure, then moving in the [001] direction, first to be observed is a plane 5 with 50% Niobium and 50% Scandium. Since the modulation amplitude A=0.5, the next plane 6 contains 100% Scandium. Following is another 50%/50% plane 7 and lastly a plane 8 containing 100% Niobium. The average composition is 50% of each B site alloy. Using ionic charges as our guide, Nb⁺⁵ and Sc⁺³ gives an average over the alloy of <B⁺⁴>. The stoichiometry of the chemical formula Pb⁺²<B⁺⁴>O₃⁻² ensures neutrality of the crystal. However, locally there is a charge difference from the mean σ=[Nb⁺⁵−<B⁺⁴>]=+1 for Niobium and σ=[<B⁺⁴>−Sc⁺³]=−1 for Scandium. This is where the charge difference and an internal electric field is realized, and a simple picture can be held knowing little but the ionic charge differences of the constituent alloys.

Now we can observe some results keeping in mind the parameters of this composition modulation.

The Effects of Composition Modulation

Now the parameters of a composition modulation scheme have been devised, the primary item of interest is the behavior of a simulated crystal with a functional changing composition. For a given wavelength and modulation shape, the properties of the crystal will be viewed as a function of amplitude. Second, they will be observed as a function of temperature. Next the effective hamiltonian will be analyzed to further understanding of the functional properties. Last, bearing all this in mind, parameters will be manipulated to illustrate the composition modulation functional properties.

Effects of Varying the Amplitude of Composition Modulation

At low temperature, 20 K, it is interesting to observe the Cartesian coordinates of the local mode vector averaged over the supercell, (uₓ, u_{y} and u_{z}) or displacements corresponding to the [100], [010] and [001] directions, as a function of the modulation parameter A, as shown in FIG. 2a. Here λ is set to 4a and the modulation scheme is that of the saw modulation presented above. For small A, A<<0.5 (including the structure for which A is null, the case of disordered PSN) exhibits a ferroelectric phase where uₓ=u_{y}=u_{z}≠0. The resulting polarization is along the [111] direction, consistent with experimental results obtained from disordered PSN¹³. As A is increased, u_{z} responds by becoming depressed while uₓ=u_{y}≠0. This configuration is that of a ferroelectric phase with monoclinic symmetry. The polarization lies between the [111] and [110] directions, the case of the M_{B} monoclinic phase. Then A reaches a point, around 0.44, where u_{z} is even further depressed to the null point while uₓ=u_{y}≠0. Then the polarization has been continuously rotated with increasing A from the [111] to the [110] direction. This results in a ground state with orthorhombic symmetry. To our knowledge, the predicted monoclinic M_{B} ground state has never been observed in any perovskite material. Similarly, we are not aware of any predictions and experiments pointing to the existence of an orthorhombic ground state in PSN. Due to the intriguing nature of these results, the task of checking these Monte Carlo outputs using the effective hamiltonian was undertaken by employing direct first-principles calculations. The local density approximation with a VCA approach provided results for 20 atom supercells; i.e. structures simulate modulations of A=0.25, 0.36 and 0.50. For each modulation simulated, there is notable agreement with the results of the effective hamiltonian. This goes very far in confirming the existence of this new M_{B} phase in PSN as well as the orthorhombic phase.

Next we can inspect the electromechanical response of the composition modulated material. The piezoelectric and dielectric responses were chosen for directions d₃₄ and χ₃₃ respectively due to the fact these exhibit the largest responses. Plotted in FIG. 2b is the piezoelectric response at low temperature, 20 K, vs. the amplitude of modulation. The peak of the shear piezoelectric response, d₃₄, occurs at A=0.375, corresponding to the steepest rate of change of u_{z} on the Local Mode vs. Amplitude of Modulation chart. This occurs near the orthorhombic to monoclinic phase transition. The peak response is on the order of 3000 pC/N which is roughly 25 times greater than the response of the disordered, and most often grown structure. This is a huge response when compared to that of materials currently being used for their piezoelectric properties (around 500 pC/N). Next plotted in FIG. 2c is the dielectric response exhibiting a peak coefficient about 15 times greater than that of the disordered structure. χ₃₃ also peaks around the orthorhombic to monoclinic phase transition. One viewpoint has attributed these large electromechanical responses to the appearance of a new phase exhibiting a lower symmetry. The mechanism for this can be understood upon inspection of the effective hamiltonian, the result is a view entailing an ease of rotating the local polarization in the crystal.

Finite Temperature Effects of Composition Modulation

Next, the properties to be examined in compositionally modulated PSN include its finite temperature behavior. FIG. 3a, the supercell average of the soft local modes vs. temperature, illustrates the finite temperature behavior of the disordered compared to the modulated structure with λ=4a and modulation amplitude A=0.375. This modulated structure is chosen due to its large electromechanical response, at low temperature, then it is compared to the disordered structure. As the disordered structure cools, it undergoes a phase transition around 373 K, from paraelectric (uₓ=u_{y}=u_{z}=0) to a ferroelectric rhombohedral configuration (uₓ=u_{y}=u_{z}≠0) and retains this phase as it is cooled. Here the Cartesian coordinates of the average local mode are ux=uy=uz, thus agreeing with experimental data [Ref. 8]. However, the modulated structure exhibits a transition at the Curie temperature (predicted 400 K,) from the paraelectric phase (of tetragonal symmetry due to the symmetry of composition modulation) to an orthorhombic structure for which uₓ=u_{y}≠0 and u_{z}=0. Then as the structure cools to 40 K, it undergoes another phase transition to the monoclinic ferroelectric M_{B} phase characterized by uₓ=u_{y}>u_{z}, with u_{z}≠0.

Interestingly upon investigation of the piezoelectric and dielectric response at a constant amplitude of modulation but with a changing temperature (FIGS. 3b and 3c), a peak in these responses is noticed at a temperature around 40 K. This is notable in that it is a very large response, greater than 8,000 pC/N and 12,000 for the piezoelectric and dielectric coefficients, respectively. This response occurs over a wide range of temperature, measuring over 1,500 pC/N and 3,000 again respectively, for any temperature less than 100 K, a remarkably broad temperature range. This peak occurs around the orthorhombic to monoclinic phase transition. Results not shown here also indicate this temperature dependent peak can be shifted upon changing the value of the parameter A. Increasing A results in a decrease in temperature at which the orthorhombic to monoclinic phase transition occurs, thus shifting the peak of the various electromechanical responses. This result is notable due to its desirable traits, a variable peak operating range. By varying A, engineers might tune a particular crystal to operate in predetermined temperature conditions, with an increased operating temperature range up to 100 K.

Understanding the Effects of Composition Modulation

To understand these results, a new perspective must be taken, one that accounts for the alloying in the crystal and corroborating the interesting results shown previously. This mechanism is the existence of an internal electric field, realized upon analysis of the units in the perturbative term of the effective hamiltonian. To illustrate the mechanism, it is necessary to rewrite the perturbative term of the effective hamiltionian, starting with the first term dependent on local mode and strain:

E_{loc}({uᵢ},{σⱼ})=Σᵢⱼρ_{|j-i|}σⱼeᵢⱼuᵢ (5)

by taking the perspective of a mean field in which the local mode vectors in the k^{th} (001) B-plane are all equal to their average (uₓ(k), u_{y}(k),u_{z}(k)) value and in which each atomic site in this k^{th} plane is associated with a compositionally averaged alloy parameter σ(k)=[+1×ν(k)]+[−1×(1−ν(k))]. Expanding the sum in the local energy over the third nearest neighbors in terms of ρ₁, ρ₂ and ρ₃ then writing:

∈_{CM}(k)=(2ρ₁+8ρ₂/√2+8ρ₃/√3)[ν(k+1)−ν(k−1)]/Z* (6)

then E_{loc} can be written:

E_{loc}=−N_{xy}ΣₖZ* u_{z}(k)∈_{CM}(k) (7)

E_{loc} is simply realized as the interaction energy of the dipole moments centered on the (001) B-planes with an (internal) electric field ∈_{CM} which is oriented along the direction of the composition modulation and which has a different value ∈_{CM}(k) in the different (001) B-planes.

∈_{CM} has an average null value, since the integration of ∈_{CM}(k) over the entire supercell is equal to zero, thus maintaining charge neutrality in the simulated crystal.

∈_{CM}(k) simply depends on the modulation and its parameters via the difference of composition between the k+1 and k−1 planes. When the limiting value of this difference in the planes above and below the point in question is taken, we arrive at the differential of the modulation function. To illustrate the finite difference between the averaged charges by plane, substitute the modulation function (ν=ν₀+A sin(2πk/λ)) into Eq. 6:

$$\begin{matrix}{ϵ}_{CM} ( k ) = {A}_{0} / {Z}^{*} ( 4 {ρ}_{1} + 16 {ρ}_{2} / √ 2 + 16 {ρ}_{3} / √ 3 ) \\ [ sin ( ( 2 π k + 1 ) / λ ) - sin ( ( 2 π k - 1 ) / λ ) ] \\ = {A}_{0} / {Z}^{*} ( 4 {ρ}_{1} + 16 {ρ}_{2} / √ 2 + 16 {ρ}_{3} / √ 3 ) \\ sin ( 2 π / λ ) cos ( 2 π k / λ )\end{matrix} \qquad ( 8 )$$

Now the resulting internal electric field is dependent on the cosine function with an argument being the plane index k. To summarize, an internal electric field is realized from the additional alloying term of the effective hamiltonian.

Now prompted by the result above, it is interesting to take a viewpoint of an electrostatic internal electric field from the outset. That is all B atoms are assigned an ionic charge of σ(k) e according to the plane in which they reside, k.

∈_{ES}(k)=−(1+2/√2+4/3√3) [σ(k+1)−σ(k−1)]/∈₀a² (9)

∈₀ is the dielectric constant and a is the cubic lattice constant of PSN. Inserting σ(k)=[+1×ν(k)]+[−1×(1−ν(k))] (where Nb has charge +1 and composition ν(k), Sc has a charge of −1 and composition 1−ν(k)) and the modulation function (again ν=ν₀+A sin(2πk/λ)) into the equation above yields:

$$\begin{matrix}{ϵ}_{ES} ( k ) = - ( 2 + 4 / √ 2 + 8 / 3 √ 3 ) [ v ( k + 1 ) - v ( k - 1 ) ] / {ϵ}_{0} {a}^{2} \\ = {A}_{0} ( 4 + 8 / √ 2 + 16 / 3 √ 3 ) sin ( 2 π / λ ) cos ( 2 π k / λ ) / {ϵ}_{0} {a}^{2}\end{matrix} \qquad ( 10 )$$

In the case that:

ρ₁=−Z*/∈₀a²

ρ₂=−Z*/2∈₀a²

ρ₃=−Z*/3∈₀a² (11)

Then Eqs. 8 and 10 show remarkable similarity, implying this local field ∈_{CM}(k) can be seen as resulting from a charge difference of the planes above and below the plane in question, as the majority of the occupants in their respective planes can have different charges. However upon further inspection, Eq. 11 is satisfied but with a discrepancy, a factor of two difference between the dielectric constant ∈₀ (around 15) and a more reasonable value for PSN (7.5). This is indicative of a role of other chemical effects besides the difference in valence charges, for example size differences, between the Sc and Nb atoms in the alloy.

Above is the key to understanding all of the interesting properties seen in our results (with more to follow). Again for a modulation with corresponding wavelength λ=4a, we can realize the results of the composition modulations to be equivalent to an internal, localized electric field (FIG. 1). With this in mind we can again observe one wavelength of the crystal structure. Starting now with a Scandium rich plane, moving through a 50%/50% composition plane toward a Niobium rich plane, we observe an internal electric field pointing in the [001] direction, located in the 50%/50% composition plane. Similarly moving from the Niobium rich plane to the Scandium rich plane an internal electric field can be observed pointing in the opposite direction. For large A (and a large internal electric field according to Eq. 10), this apparent struggle between local fields leads to a suppression of the average local mode, u_{z}, effectively encouraging instability in this direction, almost as if raising the temperature in a disordered alloy but in only one direction. For low amplitude of modulation, A, the structure is in a phase where uₓ=u_{y}=u_{z}≠0. As A increases, u_{z} decreases, leading to a monoclinic phase (uₓ=u_{y}>u_{z}) and then an orthorhombic phase (uₓ=u_{y}≠0, u_{z}=0) at high values of A. Likewise for increasing temperature, suppression of the local mode u_{z} is predicted. Low temperatures yield a rhombohedral structure, increasing temperature leads to a monoclinic structure and for highest values of T below T_{C} a paraelectric phase is observed.

Manipulating Composition Modulation Parameters to Accomplish Local Polarization Switching

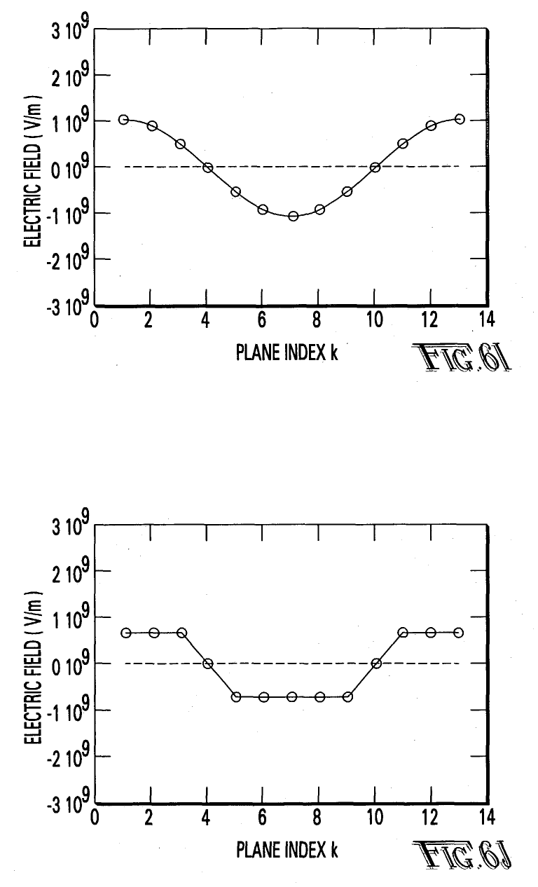

Analyzing the role of the composition modulation from the perspective of electrostatics proves to be a valuable exercise as it leads to understanding the effects of different forms and parameters of the composition modulation. FIGS. 6a-l comprise a table including: a picture of various composition modulation schemes, the Cartesian coordinates of the local modes by plane according to the above given modulation, and the calculated electric field for each modulation, ∈_{CM}(k) of Eq. 10, all indexed by plane, k. The defining parameters include the amplitude and the wavelength of modulation. The first modulation, as in FIG. 6a, is given by a sinusoidal function with an amplitude of A=0.25, half the maximum possible fluctuation amplitude. The wavelength λ=12a ensures the modulation covers twelve planes through one undulation. The Niobium concentration begins at 50%, becomes sparse, then increases and returns to 50% again, in a sinusoidal fashion. Scandium concentration has a similar behavior but phase shifted by π. The resulting local modes averaged over the supercell are presented below in FIG. 6e. uₓ, u_{y} and u_{z}, the average local modes over the supercell, are given by horizontal lines. The average local mode vectors are all equal, as they are in the disordered structure, and the overall electrical polarization then lies in the [111] direction. uₓ(k) and u_{y}(k) are equal within statistical uncertainty, and fluctuate very little by plane. u_{z}(k) sinusoidally varies around its average value u_{z} as a function of k. As a result, the polarization is rotating locally with the fluctuation of u_{z}(k). With increasing k, from 1 to 4, the polarization rotates from an intermediate direction between [001] and [111] towards the [111] direction. Then when k=4, a value where there is no difference in the composition in the planes above, k+1, and below, k−1, the polarization is that of the disordered and average structure, in the [111] direction. As k increases further, from 5 to 10, the polarization begins to rotate from the [111] direction toward the [110] direction as u_{z}(k) becomes suppressed. Then to complete the picture, for k values 11 and 12, u_{z}(k) begins to rise again and the polarization rotates through [111] towards the [001] direction. This rotation of the electrical polarization is quickly corroborated in the theoretical calculation of the local electric field, also dependent on plane index k (FIG. 6i). This is the ∈_{CM}(k) given by Eq. 8. Associated with the composition modulation is this ∈_{CM}(k), an internal electric field capable of rotating the local polarization from that of the mean structure. More precisely, a value of ∈_{CM}(k)>0 yields local mode u_{z}(k)>u_{z}. Likewise if ∈_{CM}(k)<0, local mode u_{z}(k)<u_{z}.

The next modulation given in FIG. 6c is the saw modulation. This structure differs from that of the first by only its shape of modulation. The function exhibits the same nodes and antinodes as that of the preceding modulation, but changes only linearly in between the nodes. As seen in FIG. 6f, this modulation generates a total electrical polarization (given in average local modes uₓ, u_{y} and u_{z}) congruent with the disordered PSN structure, but the local polarization can now lie in only three directions. The local electrical polarization is switching from somewhere between the [111] and [001] crystallographic directions to the [111] direction, then to a point between the [111] and [110] directions. Again this is predicted by the existence of a locally varying electric field (FIG. 6j).

The third composition modulation given is sinusoidal in nature and similar to the first modulation scheme. The difference is a doubling of the amplitude of the modulation. Then in certain planes (k=4,10) the B-site lattice is completely composed of either Scandium or Niobium. The resulting local modes by plane (uₓ(k), u_{y}(k), u_{z}(k)) have a signature reminiscent of the first modulation presented in this table. However, the amplitude of the fluctuation of u_{z}(k) has a greater peak. Also, the average local modes are now different than that of the disordered structure. uₓ and u_{y} are equal, but u_{z} is smaller than uₓ, an indication that the overall polarization is not as that of the disordered structure but lies between the [111] and [110] directions. The strain tensor corresponding to this configuration indicates this is the ground state of monoclinic symmetry. This monoclinic phase is the one denoted M_{B} in Ref. 14. Unlike the two other monoclinic and so-called M_{A} and M_{C} phases [Ref. 14] that have both been recently observed in ferroelectric alloys [Ref. 6], we are not aware of previous observation and/or prediction of the existence of a M_{B} ground state in any perovskite system.

The final modulation given in FIG. 6d is a case of a saw modulation generated by the sine function with λ=4a. This modulation differs by the wavelength of the modulation from the structure of FIG. 6b. Comparing average local modes in FIG. 6h with FIG. 6f demonstrates that the main effects of this wavelength reduction are to generate the new monoclinic ferroelectric ground state described above, and that any two successive (001) planes now have different directions for their local polarization.

### CONCLUSION

On the basis of the electrostatic considerations discussed above, we expect that any alloy made of heterovalent atoms and with a rhombohedral ground state in its disordered form should have the structural, piezoelectric and dielectric anomalies displayed in FIGS. 2 and 3, when the atomic ordering along the [001] direction is adjusted in a certain way. The atomically-ordered structures discussed here could be grown by means of a pulse laser deposition technique [Ref. 17] or by using molecular beam epitaxy.

In summary, new ferroelectric alloy materials having enhanced electromechanical properties may be obtained by rearranging the ordering of atoms in stacked planes meeting the following requirements:

(1) the alloy is atomically ordered along a direction that is not the direction of polarization of the disordered alloy;

(2) the stacking is short; e.g., a four-plane period has been calculated to produce large enhancements; and

(3) the atoms belong to different columns of the periodic table.

### REFERENCES

1. Abe, K. & Komatsu, S. Ferroelectric properties in epitaxially grown BaₓSr₁₋ₓTiO₃ thin films, J. Appl. Phys., 77, 6461-6465 (1995).

2. Uchino, K. Piezoelectric Actuators and Ultrasonic Motors (Kluwer Academic, Boston, 1996).

3. Sai, N., Meyer, B. & Vanderbilt, D. Compositional inversion symmetry breaking in ferroelectric perovskites, Phys. Rev. Lett. 84, 5636-5639 (2000).

4. Park, S.-E. & Shrout, T. R. Ultrahigh strain and piezoelectric behavior in relaxor based ferroelectric single crystal, J. Appl. Phys., 82, 1804-1811 (1997).

5. Service, R. F. Shape-changing crystals get shiftier, Science 275, 1878 (1997).

6. Noheda, B. et al. A monoclinic ferroelectric phase in the Pb(Zr₁₋ₓTiₓ)O₃ solid solution, Appl. Phys. Lett. 74, 2059-2061 (1999).

7. Bellaiche, L., Garcia, A. & Vanderbilt, D. Finite-temperature properties of Pb(Zr₁₋ₓTiₓ)O₃ Alloys from first principles, Phys. Rev. Lett. 84, 5427-5430 (2000).

8. Hemphill, R., Bellaiche, L., Garcia, A. & Vanderbilt, D., Finite-temperature properties of disordered and ordered Pb(Sc_{0.5}Nb_{0.5})O₃ alloys, Appl. Phys. Lett., 77, 3642-3644 (2000).

9. Hohenberg, P. & Kohn, W. Inhomogeneous electron gas, Phys. Rev. 136, B864-871 (1964)

10. Kohn, W. & Sham, L. J. Self-consistent equations including exchange and correlation effects, Phys. Rev. 140, A1133-1138 (1965).

11. Vanderbilt, D. Soft self-consistent pseudopotentials in a generalized eigenvalue formalism, Phys. Rev. B 41, 7892-7895 (1990).

12. Bellaiche, L. & Vanderbilt, D. Virtual crystal approximation revisited: Application to dielectric and piezoelectric properties of perovskites, Phys. Rev. B 61, 7877-7882 (2000).

13. Chu, F., Reaney, I. M. & Setter, N. Spontaneous (zero-field) relaxor-to-ferroelectric-phase transition in disordered Pb(Sc_{1/2}Nb_{1/2})O₃, J. Appl. Phys. 77, 1671-1676 (1995).

14. Vanderbilt, D. & Cohen, M. H Monoclinic and triclinic phases in higher-order Devonshire theory, Phys. Rev. B, 63, 094108 (2001).

15. Ramer, N. J. & Rappe, A. M. Application of a new virtual crystal approach for the study of disordered perovskites, J. Phys. Chem. Solids, 61, 315-320 (2000).

16. Fu, H. & Cohen, R. E. Polarization rotation mechanism for ultrahigh electromechanical response in single crystal piezoelectrics, Nature 403, 281-283 (2000).

17. Brazier, M., McElfresh, M. & Mansour, S. Unconventional hysteresis behavior in compositionally graded Pb(Zr,Ti)O₃ thin films, Appl. Phys. Lett. 72, 1121-1123 (1998).

What is claimed is:

1. A ferroelectric material, comprising:
a perovskite alloy comprising stacked planes of the form (A′A″A′″ . . . )(B′_{x′(k)}B″_{x″(k)}B′″_{x′″(k)} . . . )X₃, wherein A′,A″,A′″, . . . , B′,B″,B′″, . . . and X₃ represent atomic species, wherein at least two of B′, B″, B′″, . . . belong to different columns of the periodic table and wherein x′(k), x″(k), x′″(k), . . . are modulated parameters yielding the relative concentration of the B′, B″, B′″, . . . atoms, respectively, in each plane, k, of said alloy;
wherein said alloy is atomically ordered along a direction that is not the direction of polarization of the disordered alloy;
wherein said planes are stacked with a short stacking period; and
wherein said modulated parameters x′(k), x″(k), x′″(k), . . . are selected to obtain at a specific temperature dielectric and piezoelectric properties of said alloy that are substantially enhanced over the dielectric and piezoelectric properties of the disordered alloy, said specific temperature being selected from any temperature less than the Curie temperature of the disordered alloy.

2. The ferroelectric material of claim 1, wherein said stacking period is a four-plane period.

3. The ferroelectric material of claim 1, wherein said A′ atom is lead, with no other A site atoms.

4. The ferroelectric material of claim 1, wherein said B′ atom is Scandium.

5. The ferroelectric material of claim 1, wherein said B″ atom is Niobium.

6. The ferroelectric material of claim 1 having no B site alloying elements other than Scandium and Niobium.

7. The ferroelectric material of claim 1, where said X atom is oxygen.

8. The ferroelectric material of claim 1, wherein said direction along which said alloy is atomically ordered is along the [001] direction.

9. A ferroelectric material, comprising:
a perovskite alloy comprising stacked planes of the form (A′_{x′(k)}A″_{x″(k)}A′″_{x′″(k)} . . . )(B′B″B′″ . . . )X₃, wherein A′,A″,A′″, . . . , B′,B″,B′″, . . . and X₃ represent atomic species, wherein at least two of A′, A″, A′″, . . . belong to different columns of the periodic table and wherein x′(k), x″(k), x′″(k), . . . , are modulated parameters yielding the relative concentration of the A′, A″, A′″, . . . atoms, respectively, in each plane, k, of said alloy;
wherein said alloy is atomically ordered along a direction that is not the direction of polarization of the disordered alloy;
wherein said planes are stacked with a short stacking period; and
wherein said modulated parameters x′(k), x″(k), x′″(k), . . . are selected to obtain at a specific temperature dielectric and piezoelectric properties of said alloy that are substantially enhanced over the dielectric and piezoelectric properties of the disordered alloy, said specific temperature being selected from any temperature less than the Curie temperature of the disordered alloy.

10. The ferroelectric material of claim 9, wherein said stacking period is a four-plane period.

11. The ferroelectric material of claim 9, where said X atom is oxygen.
